(19) United States
(12) Patent Application Publication
(10) Pub. No.: US 2025/0216056 A1
(43) Pub. Date: Jul. 3, 2025

(54) LIGHT ADJUSTMENT DEVICE AND ILLUMINATION DEVICE

(71) Applicant: LUXSHARE PRECISION INDUSTRY COMPANY LIMITED, Baoan Shenzhen (CN)

(72) Inventors: Hsi-Sheng HSIA, Baoan Shenzhen (CN); Jhih-Li LIN, Baoan Shenzhen (CN)

(21) Appl. No.: 18/674,172

(22) Filed: May 24, 2024

(30) Foreign Application Priority Data
Dec. 28, 2023 (CN) 2023236146053

(51) Int. Cl. F21V 14/04; G02B 26/08

(52) U.S. Cl. CPC F21V 14/04; G02B 26/0825

(57) ABSTRACT

A light adjustment device and an illumination device are disclosed. The light adjustment device includes a base, a piezoelectric component, and a flexible reflective sheet. The base is for disposing a light emission device thereon. The piezoelectric component is mounted on the base and generates a deformation amount with a preset value toward a preset direction by changing the voltage inputted to the piezoelectric component. One side of the flexible reflective sheet is fixed on the piezoelectric component. The flexible reflective sheet generates a preset bend to form a reflective curved surface by the deformation of the piezoelectric component, and the light emitted by the light emission device partially projects or entirely projects onto the reflective curved surface of the flexible reflective sheet and is reflected on a preset position.

### FIELD OF THE INVENTION

The present disclosure is related to a technical field of illumination devices, and specifically, is related to a light adjustment device and an illumination device.

### BACKGROUND OF THE INVENTION

In an actual working life, some illumination devices require to have a function of light adjustments in order to adapt to different requirements. The light adjustments are related to color temperature adjustments, projection direction adjustments and projection range adjustments.

The illumination device such as a table lamp and a pendant lamp generally has the functions of color temperature adjustments, light projection direction adjustments, and the light projection direction adjustments are implemented by changing the pitch angle of the table lamp or the pendant lamp. When a user looks a book, the wide projection range of the light is usually needed so that the eyes of the user can be protected and the user can clearly look the content of the book. When the user utilizes the table lamp or the pendant lamp to illuminate a computer region, usually, a keyboard region is just needed to illuminate, and thus, the narrow projection range of the light is merely needed. However, the shape of the reflector of the illumination device such as the table lamp and the pendant lamp is fixed, and the projection range of the light is unable to adjust, and thus, the various requirements can merely be met by adjusting the light projection direction.

In addition, a headlamp of a car can implement switching between far light illumination and near light illumination, and in other words, the headlamp of the car can adjust the projection direction and the projection range of the light. In order to implement the aforementioned adjustments, a common car has two configurations: a low beam headlight and a high beam headlight, and the low beam headlight and the high beam headlight are configured to have two reflectors with different angles of inclinations, thereby realizing the far light illumination and the near light illumination.

### SUMMARY OF THE INVENTION

The object of the present embodiments of the present disclosure is to provide a light adjustment device and an illumination device which can implement the adjustments of the projection direction and the projection range of the light and can change the position of the illumination edge of the light to realize adjustments of the shape of the light.

In the first aspect, a light adjustment device is provided and includes a base, a piezoelectric component and a flexible reflective sheet. The base is for disposing a light emission device thereon. The piezoelectric component is mounted on the base and generates a deformation amount with a preset value toward a preset direction by changing the voltage inputted to the piezoelectric component is changed. One side of the flexible reflective sheet is fixed on the piezoelectric component. The flexible reflective sheet generates a preset bend to form a reflective curved surface by the deformation of the piezoelectric component, and the light emitted by the light emission device partially projects or entirely projects onto the reflective curved surface and is reflected on a preset position.

In some embodiments, the piezoelectric component is a multilayer structure, and the surface on the one side of the flexible reflective sheet is attached to the surface of the piezoelectric component, and the flexible reflective sheet is connected and fixed to the piezoelectric component.

In some embodiments, the light adjustment device further includes a constraint part, and the preset distance between the constraint part and the piezoelectric component is constant, and the relative position relationship between the constraint part and the piezoelectric component is invariable. The flexible reflective sheet includes a first side fixed on the piezoelectric component and a second side constrained by the constraint part.

In some embodiments, the light adjustment device further includes a support frame which is fixed and connected to the base, and the support frame has a bent surface toward the flexible reflective sheet. When the voltage inputted to the piezoelectric component is a first voltage, the flexible reflective sheet is bent to attach to the bent surface; when the voltage inputted to the piezoelectric component is zero, the flexible reflective sheet is on a freely bent state; when the voltage inputted to the piezoelectric component is a second voltage, at least one partial surface of the flexible reflective sheet is bent to detach from the bent surface.

In some embodiments, the constraint part is one part of the support frame, and the second side of the flexible reflective sheet is connected and fixed to the constraint part.

In some embodiments, the light adjustment device further includes an opaque outer case with an opening. The base, the support frame and the flexible reflective sheet are encased by the outer case, and the light reflected by the reflective surface of the flexible reflective sheet travels from the opening of the outer case.

In some embodiments, one end of the support frame far away from the piezoelectric component and the outer case forms the constraint part with a form of an included angle structure, and the second side of the flexible reflective sheet is inserted into the included angle structure.

In some embodiments, the opening of the outer case includes a first side adjacent to the base and a second side adjacent to the flexible reflective sheet. An attachment surface with a preset arc is disposed on the second side of the opening. When the voltage inputted to the piezoelectric component is the second voltage, the surface of the second side of the flexible reflective sheet is attached to at least one partial surface of the attachment surface.

In some embodiments, when the flexible reflective sheet is bent to attach to the bent surface, the light emitted by the light emission device mounted on the base projects onto the reflective curved surface of the flexible reflective sheet and is reflected to form a first light beam. When the at least one partial surface of the flexible reflective sheet is bent to detach from the bent surface, the light emitted by the light emission device mounted on the base projects onto the reflective curved surface of the flexible reflective sheet and is reflected to form a second light beam. The first light beam projects onto a preset surface to form a first near illumination edge and a first far illumination edge, and the distance between the first near illumination edge and the first far illumination edge is denoted as a first distance. The second light beam projects onto the preset surface to form a second near illumination edge and a second far illumination edge, and the distance between the second near illumination edge and the second far illumination edge is denoted as a second distance. The first distance is greater than the second distance, and the first far illumination edge is farther from the light emission device than the second far illumination edge, and the first near illumination edge is farther from the light emission device than the second near illumination edge.

In some embodiments, the flexible reflective sheet includes a first surface and a second surface which face away from each other, and one side of the first surface on the first side of the flexible reflective sheet is attached and fixed to the piezoelectric component; at least one part of the second surface faces the light emission device and the second surface is configured to receive the light emitted by the light emission device. When the voltage inputted to the piezoelectric component is the second voltage, at least one part of the first surface of the flexible reflective sheet withstands on the bent surface of the support frame.

In some embodiments, when the voltage inputted to the piezoelectric component is zero, the flexible reflective sheet is on the freely bent state and includes a first bent part and a second bent part, and the bending direction of the first bent part is opposite to the bending direction of the second bent part. When the voltage inputted to the piezoelectric component is greater than zero, the curvature of the first bent part and the curvature of the second bent part are changed by the deformation of the piezoelectric component.

In the second aspect, an illumination device is further provided and includes a base, a piezoelectric component, a flexible reflective sheet and a fixing base. The base is for disposing a light emission device thereon. The piezoelectric component is mounted on the base and generates a deformation amount with a preset value toward a preset direction by changing the voltage inputted to the piezoelectric component is changed. One side of the flexible reflective sheet is fixed on the piezoelectric component. The top of the fixing base is configured to mount the light adjustment device, and the bottom of the fixing base is configured to clamp on a preset object or is configured to be placed on a preset plane. The flexible reflective sheet generates a preset bend to form a reflective curved surface by the deformation of the piezoelectric component, and the light emitted by the light emission device partially projects or entirely projects onto the reflective curved surface and is reflected on a preset position.

In some embodiments, the base is a circuit board which drives the piezoelectric component and the light emission device to operate.

In some embodiments, the illumination device further includes a first circuit board and a second circuit board which are independent of each other and mounted on the base, and the piezoelectric component is mounted on the first circuit board, and the light emission device is mounted on the second circuit board.

In some embodiments, the flexible reflective sheet is an elastic metal sheet.

In comparison with the prior art, the beneficial effect of the present disclosure at least includes:

During use, the light adjustment device and the illumination device provided by the present disclosure generate the deformation amount with different degrees and different directions on the piezoelectric component by changing the value and/or the direction of the voltage inputted to the piezoelectric component, and the deformation amount with different degrees and different directions on the piezoelectric component further results in the displacement variations and the bending of the piezoelectric component to a certain degree to form the reflective curved surface with different bending directions. The reflective curved surface with different bending directions not only changes the projection direction of the reflected light but also changes the projection range of the light so that the illumination edge of the certain surface projected by the light generates variations. In other words, the light convergence and the light divergence on the particular region and the adjustments of the projection shape of the light are realized.

### THE DRAWINGS

In order to clearly describe the technical solutions provided by the embodiments of the present disclosure, the accompanying drawings which the embodiments of the present disclosure require are simply explained as follows. It should be appreciated that the accompanying drawings in the following description are merely some embodiments of the present disclosure and are not construed as the limitations of the present disclosure. The person skilled in the art may obtain the other drawings according to the accompanying drawings provided by the present disclosure without any inventive steps.

FIG. 1 is a schematic structure diagram of a first type light adjustment device in a free state according to the embodiments of the present disclosure.

FIG. 2 is a schematic structure diagram of a first type light adjustment device in a light adjustment state according to the embodiments of the present disclosure.

FIG. 3 and FIG. 4 are schematic diagrams of operation principles of a piezoelectric component according to the embodiments of the present disclosure.

FIG. 5 is a schematic structure diagram of a second type light adjustment device in a free state according to the embodiments of the present disclosure.

FIG. 6 is a schematic diagram of a first type light shape of a light adjustment device in FIG. 5 according to the embodiments of the present disclosure.

FIG. 7 is a schematic diagram of a second type light shape of a light adjustment device in FIG. 5 according to the embodiments of the present disclosure.

FIG. 8 is a schematic structure diagram of a flexible reflective sheet of a light adjustment device in a freely bent state according to the embodiments of the present disclosure.

FIG. 9 is a structure diagram of a light adjustment device with a support frame and an outer case in a first state according to the embodiments of the present disclosure.

FIG. 10 is a structure diagram of a light adjustment device with a support frame and an outer case in a second state according to the embodiments of the present disclosure.

FIG. 11 is a schematic diagram of a light shape of a light adjustment device in FIG. 9 according to the embodiments of the present disclosure.

FIG. 12 is a schematic diagram of a light shape of a light adjustment device in FIG. 10 according to the embodiments of the present disclosure.

FIG. 13 is a schematic structure diagram of an illumination device according to the embodiments of the present disclosure.

### DETAILED DESCRIPTION

In order to clearly understand about the objects, the technical solutions and the advantages of the present disclosure, the technical solutions in the embodiments of the present disclosure would be clearly and thoroughly understood by combing the accompanying drawings and the detailed description as below. Apparently, the described embodiments are one part of the embodiments of the present disclosure instead of the entire embodiments of the present disclosure. The assembly of the embodiments of the present disclosure described and shown in the drawings may be arranged and designed by various configurations.

Hence, the detailed descriptions provided by the embodiments of the present disclosure in the drawings as below are not aimed to limit the scope of the protection of the present disclosure but merely shows the selected embodiments of the present disclosure. Based on the embodiments of the present disclosure, the other embodiments which the person skilled in the art can obtain without any inventive steps shall fall within the scope of protection of the present disclosure.

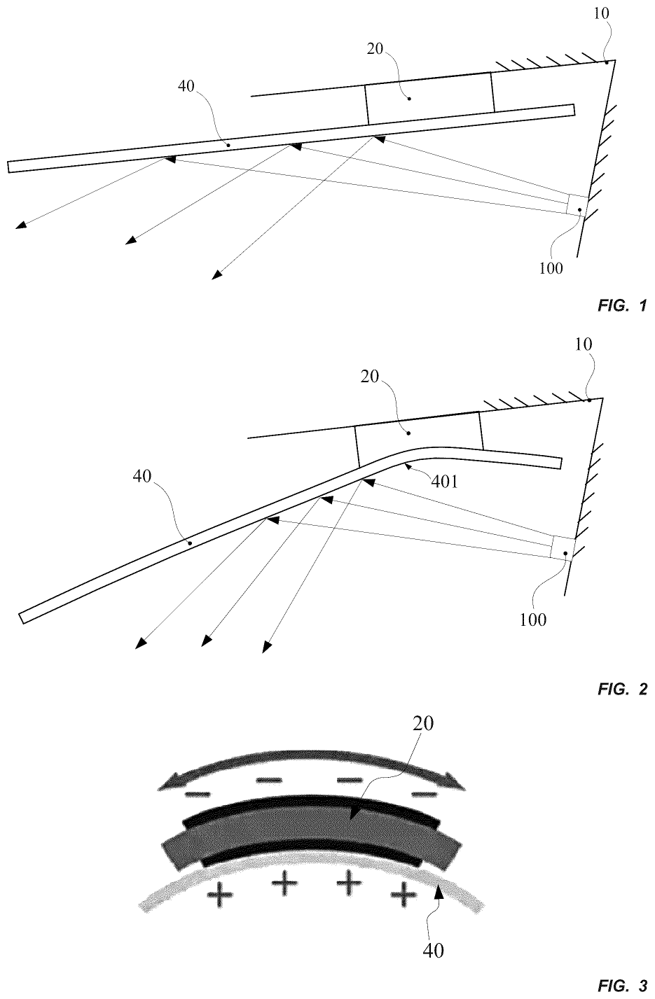

As shown in FIG. 1 and FIG. 2, the present embodiment provides a light adjustment device including a base 10, a piezoelectric component 20 and a flexible reflective sheet 40. The base 10 is for disposing a light emission device 100 thereon, and the base 10 may be a circuit board which drives the piezoelectric component 20 and the light emission device 100 to operate, or the piezoelectric component 20 and the light emission device 100 may have circuit boards independent of each other, and then the circuit board with the piezoelectric component 20 and the circuit board with the light emission device 100 are respectively mounted on the base 10. For example, the piezoelectric component 20 is mounted on a first circuit board, and the light emission device 100 is mounted on a second circuit board, and the first circuit board and the second circuit board are mounted on the base 10.

The piezoelectric component 20 is mounted on the base 10, and the piezoelectric component 20 generates a deformation amount with a preset value toward a preset direction by changing a voltage inputted to the piezoelectric component. One side of the flexible reflective sheet 40 is fixed on the piezoelectric component 20, and the flexible reflective sheet 40 generates a preset bend to form a reflective curved surface 401 by the deformation of the piezoelectric component 20, and the light emitted by the light emission device 100 partially projects or entirely projects onto the reflective curved surface 401 of the flexible reflective sheet 40 and is reflected on a preset position.

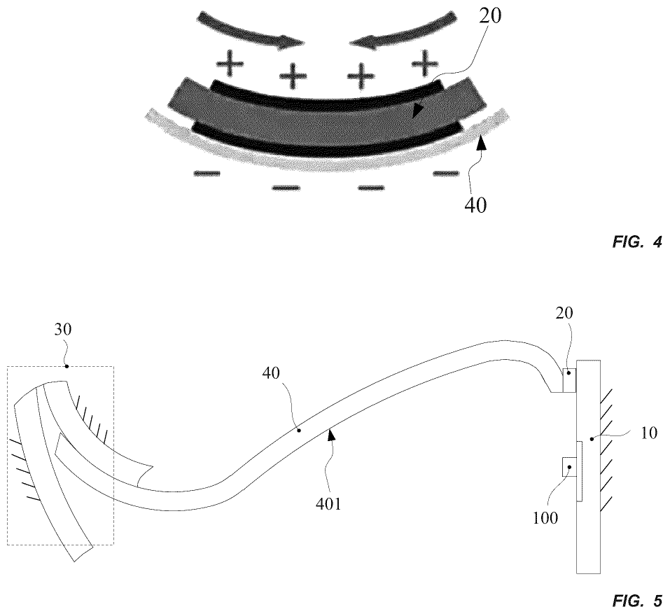

In the present embodiment, as shown in FIG. 3 and FIG. 4, the piezoelectric component 20 may be a multilayer structure, and the surface on the one side of the flexible reflective sheet 40 is attached to the surface of the piezoelectric component 20, and the flexible reflective sheet 40 is connected and fixed to the piezoelectric component 20. A voltage is inputted to the piezoelectric component 20 with the multilayer structure to arise the deformation of the piezoelectric component 20, and the variations of the value and the direction of the voltage may change the deformation direction and the deformation amount of the piezoelectric component 20. Furthermore, the deformation of the piezoelectric component 20 may drive the flexible reflective sheet 40 to generate bending to a certain degree, and the position and the curvature of the reflective curved surface 401 also change accordingly.

In addition to the structural form of the flexible reflective sheet 40 shown in in FIG. 3 and FIG. 4, the side part of the flexible reflective sheet 40 may be fixed on the surface of the piezoelectric component 20, and the deformation of the piezoelectric component 20 changes the position of the flexible reflective sheet 40, and further, the reflection direction and the reflection range of the light are changed.

In the present embodiment, a control device may be disposed and is configured to adjust the value and the direction of the voltage inputted to the piezoelectric component 20. The control device may have a value control switch and a direction control switch. The value control switch may be a rotary switch or consist of a plurality of push switches to realize the adjustments of the value of the voltage.

The direction control switch has three gears including a positive direction, a negative direction and a shutdown, and the adjustments of the direction of the voltage is realized by switching to different gears.

In the present embodiment, the flexible reflective sheet 40 may be an elastic metal sheet, and the flexible reflective sheet 40 may be bent when the flexible reflective sheet 40 undergoes force, and the flexible reflective sheet 40 may be restored to an initial state when the flexible reflective sheet 40 does not undergo force, and the surface on one side of the flexible reflective sheet 40 toward the light emission device 100 has high reflectivity.

According to the above description, during use, the light adjustment device of the present embodiment generates the deformation amount with different degrees and different directions on the piezoelectric component 20 by changing the value and/or the direction of the voltage inputted to the piezoelectric component 20, and the deformation amount with different degrees and different directions on the piezoelectric component 20 further results in the displacement variations and the bending of the piezoelectric component 20 to a certain degree to form the reflective curved surface 401 with different bending directions. The reflective curved surface 401 with different bending directions not only changes the projection direction of the reflected light but also changes the projection range of the light so that the illumination edge of the certain surface projected by the light generates variations. In other words, the light convergence and the light divergence on the particular region and the adjustments of the projection shape of the light are realized.

In the present embodiment, as shown in FIG. 5, the light adjustment device may further include a constraint part 30, the preset distance between the constraint part 30 and the piezoelectric component 20 is constant, and the relative position relationship between the constraint part 30 and the piezoelectric component 20 is invariable. The flexible reflective sheet 40 includes a first side and a second side, the first side of the flexible reflective sheet 40 is fixed on the piezoelectric component 20 and the second side of the flexible reflective sheet 40 is constrained by the constraint part 30.

The purpose of the constraint part 30 is to realize the constraints of the second side of the flexible reflective sheet 40, “constraints” may be understood that the second side of the flexible reflective sheet 40 is fixed and the position of the flexible reflective sheet 40 is invariable, and “constraints” may be also understood that the second side of the flexible reflective sheet 40 is constrained to move in a preset limited distance or in a limited space. Thus, when the piezoelectric component 20 generates the deformation and transmits a deforming force to the flexible reflective sheet 40 by the first side of the flexible reflective sheet 40, the deforming force may bend the part between the first side and the second side of the flexible reflective sheet 40 because the second side of the flexible reflective sheet 40 is constrained, and the bending of the part between the first side and the second side of the flexible reflective sheet 40 facilitates the formation of the reflective curved surface 401 and contributes to the greater adjusting range of the bending deformation of the reflective curved surface 401.

During use, the light adjustment device of the present embodiment generates the deformation amount with different degrees and different directions on the piezoelectric component 20 by changing the value and/or the direction of the voltage inputted to the piezoelectric component 20, and under the constraints of the constraint part 30, the part between the first side and the second side of the flexible reflective sheet 40 generates more bending to form the reflective curved surface 401 which has bending directions with greater differences. Thus, the variations of the projection direction and the projection range of the reflected light would be greater to realize the adjustments of the projection shape of the light with more differences.

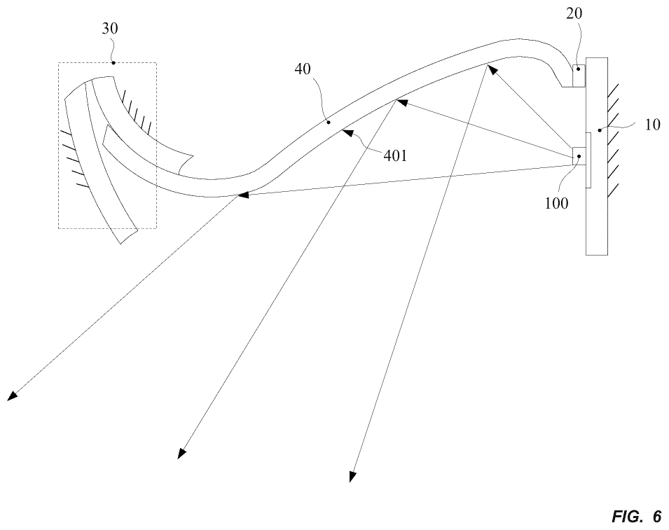

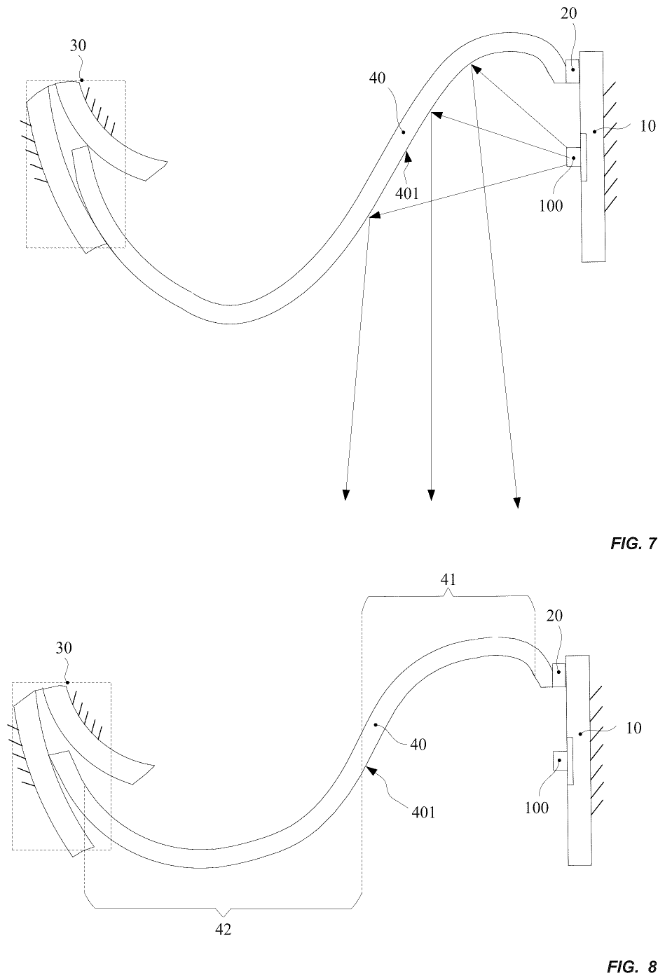

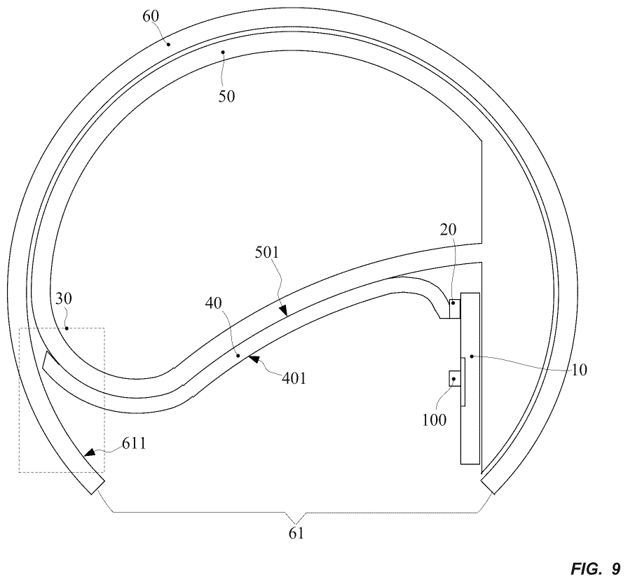

For example, when the flexible reflective sheet 40 is situated on the bending state as shown in FIG. 6, the light is reflected on a farther position by the reflective curved surface 401, and the projection range of the light is wider. When the flexible reflective sheet 40 is situated on the bending state as shown in FIG. 7, the light is reflected on a closer position by the reflective curved surface 401, and the projection range of the light is narrower.

At the same time, when the light adjustment device of the present embodiment is applied to a table lamp and a pendant lamp of a display, the adjustments of the projection direction and the projection range of the light may be realized. For example, the light as shown in FIG. 6 may be suitable for the scene where the user reads the book, the projection direction of the light is farther, and the projection range of the light is wider, and the farther projection direction and the wider projection range of the light may be beneficial for protecting eyes of a user and be helpful for the user to clearly look content of a book. Moreover, the light as shown in FIG. 7 may be suitable for the scene where the user uses a computer in a dark environment, the projection direction of the light is closer, and the projection range of the light is narrower, and the light may be focused on a keyboard position.

Furthermore, when the light adjustment device of the present embodiment is applied to a headlamp of a car, one light emission device 100 is merely required, and then, the adjustments of far light illumination and near light illumination are realized by the variations of the bending of the flexible reflective sheet 40, and the original low beam headlight and the original high beam headlight of the car may be reduced to one light emission device 100.

In the present embodiment, as shown in FIG. 8, when the voltage inputted to the piezoelectric component 20 is zero, the flexible reflective sheet may be on a freely bent state, and the flexible reflective sheet 40 includes a first bent part 41 and a second bent part 42, and the bending direction of the first bent part 41 is opposite to the bending direction of the second bent part 42. When the voltage inputted to the piezoelectric component 20 is greater than zero, the curvature of the first bent part 41 and the curvature of the second bent part 42 are changed by the deformation of the piezoelectric component 20.

It should be noted that the nature state of the flexible reflective sheet 40 may be configured to have the multiple bending parts by performing the presetting technology on the flexible reflective sheet 40.

When the bending of the flexible reflective sheet 40 arises from the deformation of the piezoelectric component 20, the first bent part 41 and second bent part 42 can have guiding effects on the bending motion of the flexible reflective sheet 40 and be beneficial to control the bending direction of the flexible reflective sheet 40.

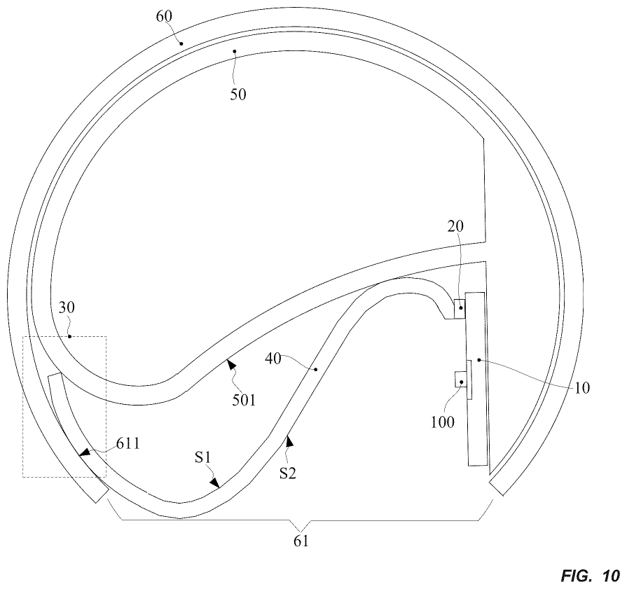

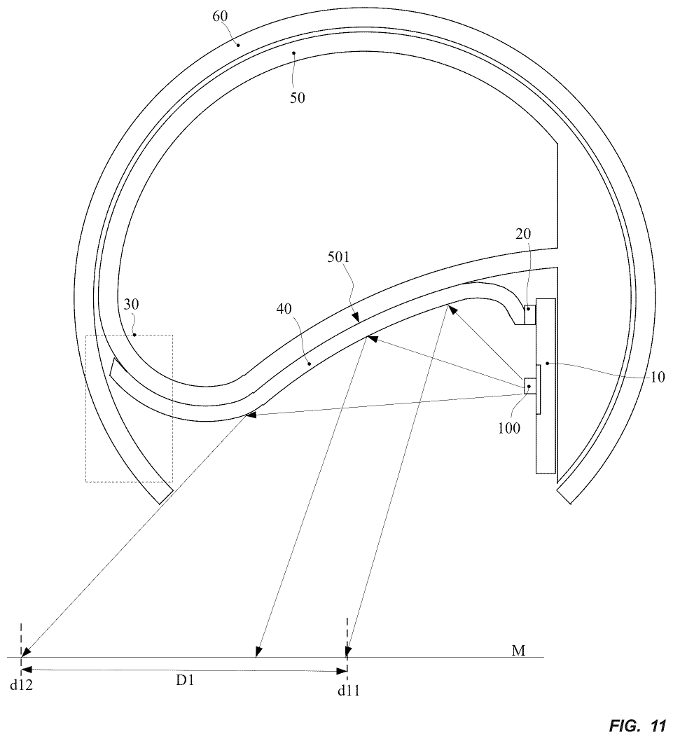

In the present embodiment, as shown in FIG. 9 and FIG. 10, the light adjustment device further includes a support frame 50 which is fixed and connected to the base 10, and the support frame 50 has a bent surface 501 toward the flexible reflective sheet 40.

As shown in FIG. 9, when the voltage inputted to the piezoelectric component 20 is a first voltage, the flexible reflective sheet 40 is bent to attach to the bent surface 501. As shown in FIG. 10, when the voltage inputted to the piezoelectric component 20 is a second voltage, at least one partial surface of the flexible reflective sheet 40 is bent to detach from the bent surface 501. When the voltage inputted to the piezoelectric component 20 is zero, the flexible reflective sheet is on the freely bent state, and the freely bent state may be similar to the state as shown in FIG. 9, may be similar to the state as shown in FIG. 10, or may be between the state as shown in FIG. 9 and the state as shown in FIG. 10.

In the present embodiment, as shown in FIG. 9, when the flexible reflective sheet 40 is bent toward a direction close to the support frame 50, the flexible reflective sheet 40 is bent to attach the bent surface 501 and is unable to further bend. It may be seen from the above description that the bending of the flexible reflective sheet 40 toward the direction close to the support frame 50 is constrained by the bent surface 501.

It should be noted that the direction of the first voltage and the direction of the second voltage may be the same, and the value of the first voltage and the value of the second voltage may be different. In another embodiment, the direction of the first voltage and the direction of the second voltage may be different, and the value of the first voltage and the value of the second voltage may be the same. In yet another embodiment, the direction of the first voltage and the direction of the second voltage may be different, and the value of the first voltage and the value of the second voltage may be different. According to the position of the flexible reflective sheet 40 relative to the light emission device 100 and the actual use requirements of the light, the person skilled in the art may adjust the values and the directions of the first voltage and the second voltage, and thus, the values and the directions of the first voltage and the second voltage herein are not distinctly limited.

In the present embodiment, as shown in FIG. 10, when the voltage inputted to the piezoelectric component 20 is the second voltage, one part of the flexible reflective sheet 40 withstands on the bent surface 501, and in other words, the constraints of the flexible reflective sheet 40 are formed by the bent surface 501, and the bent surface 501 can also have the guiding and limiting effects on the bending of the flexible reflective sheet 40.

For example, specifically, as shown in FIG. 10, the flexible reflective sheet 40 includes a first surface S1 and a second surface S2 which face away from each other, one side of the first surface S1 on the first side of the flexible reflective sheet 40 is attached and fixed to the piezoelectric component 20; at least one part of the second surface S2 faces the light emission device 100, and the second surface S2 is configured to receive the light emitted by the light emission device 100. When the voltage inputted to the piezoelectric component 20 is the second voltage, at least one part of the first surface S1 of the flexible reflective sheet 40 withstands on the bent surface 501 of the support frame 50.

As seen from the above description and FIG. 10, the piezoelectric component 20 constrains the first side of the flexible reflective sheet 40, and the constraint part 30 constrains the second side of the flexible reflective sheet 40, and the bent surface 501 of the support frame 50 may have limiting effects on the certain position between the first side and the second side of the flexible reflective sheet 40, and by the constraints of the positions of the piezoelectric component 20, the constraint part 30 and the bent surface 501, the flexible reflective sheet 40 can be greatly guided to bend along the expected direction.

In the present embodiment, as shown in FIG. 11, when the flexible reflective sheet 40 is bent to attach to the bent surface 501, the light emitted by the light emission device 100 projects onto the reflective curved surface 401 of the flexible reflective sheet 40 and is reflected to form a first light beam. As shown in FIG. 10, when the at least one partial surface of the flexible reflective sheet 40 is bent to detach from the bent surface 501, the light emitted by the light emission device 100 projects onto the reflective curved surface 401 of the flexible reflective sheet 40 and is reflected to form a second light beam.

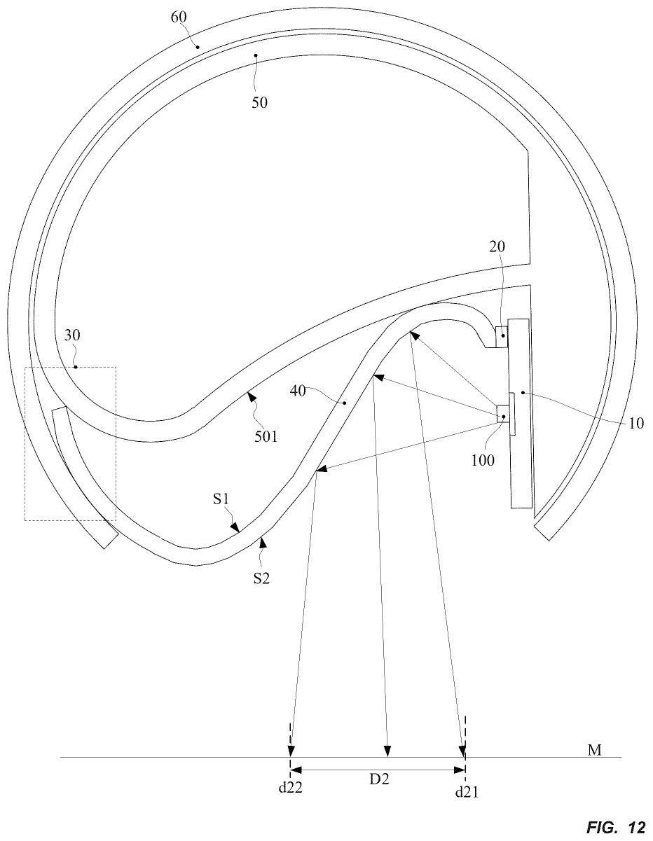

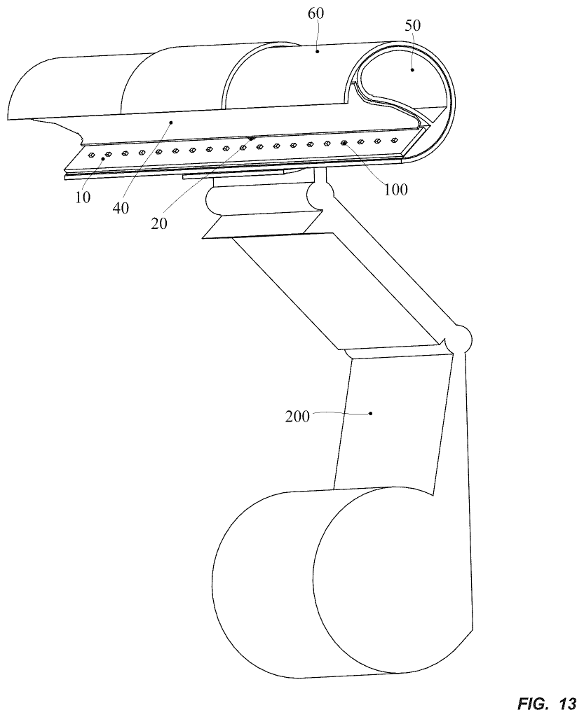

As shown in FIG. 11, the first light beam projects onto a preset surface M to form a first near illumination edge d11 and a first far illumination edge d12, and the distance between the first near illumination edge d11 and the first far illumination edge d12 is denoted as a first distance D1. As shown in FIG. 12, the second light beam projects onto the preset surface M to form a second near illumination edge d21 and a second far illumination edge d22, and the distance between the second near illumination edge d21 and the second far illumination edge d22 is denoted as a second distance D2. As seen from the comparison of FIG. 11 and FIG. 12, the first distance D1 is greater than the second distance D2, the first far illumination edge d12 is farther from the light emission device 100 than the second far illumination edge d22, and the first near illumination edge d11 is farther from the light emission device than the second near illumination edge d21.

In an actual application, when the light adjustment device is used in the scene where the user reads the book, the shape of the light may be changed into the shape of the first light beam as shown in FIG. 11, and the projection direction of the light is farther, and the projection range of the light is wider. When the light adjustment device is used in the scene where the user uses the computer, the shape of the light may be changed into the shape of the second light beam as shown in FIG. 12, and the projection direction of the light is farther, and the projection range of the light is wider.

In the present embodiment, as shown in FIG. 9 and FIG. 10, the light adjustment device may further include an opaque outer case 60 with an opening 61. The base, the support frame 50 and the flexible reflective sheet 40 are encased by the outer case 60, and the light reflected by the reflective surface 401 of the flexible reflective sheet 40 travels from the opening 61 of the outer case 60. The outer case 60 is convenient for encasing and protecting the other components and can prevent the light from escaping.

In the present embodiment, as shown in FIG. 9 and FIG. 10, one end of the support frame 50 far away from the piezoelectric component 20 and the outer case 60 forms the constraint part 30 with a form of an included angle structure, and the second side of the flexible reflective sheet 40 is inserted into the included angle structure.

In the present embodiment, the constraint part 30 is one part of the support frame 50, and the second side of the flexible reflective sheet 40 is connected and fixed to the constraint part 30, and the fixing and constraining effects are formed by just depending on the connection of the second side of the flexible reflective sheet 40 and the support frame 50.

In the present embodiment, as shown in FIG. 9 and FIG. 10, the opening 61 of the outer case 60 includes a first side and a second side, the first side of the opening 61 is adjacent to the base 10 and the second side of the opening 61 is adjacent to the flexible reflective sheet 40; an attachment surface 611 with a preset arc is disposed on the second side of the opening 61; when the voltage inputted to the piezoelectric component 20 is the second voltage, the surface of the second side of the flexible reflective sheet 40 is attached to at least one partial surface of the attachment surface 611. When the second side of the flexible reflective sheet 40 is bent toward a direction far away from the bent surface 501, the attachment surface 611 may have constraint effects on the second side of the flexible reflective sheet 40 to prevent the excessive bending of the flexible reflective sheet 40.

As shown in FIG. 13, the present embodiment further provides an illumination device including the light adjustment device as described above and the light emission device 100. The light emission device 100 is mounted on the base 10 of the light adjustment device. The light emission device 100 may include one LED or multiple LEDs.

It should be noted that the illumination device provided by the present embodiment may be various apparatus such as the table lamp, the pendant lamp of the display or the headlamp of the car.

In the present embodiment, as shown in FIG. 13, the illumination device further includes a fixing base 200, the top of the fixing base 200 is configured to mount the light adjustment device, and the bottom of the fixing base 200 is configured to clamp on a preset object or is configured to be placed on a preset plane. Taking an example, the illumination device is the table lamp, and the fixing base 200 may be clamped on the edge of the table or be placed on the table. Taking another example, the illumination device is the pendant lamp of the display, and the fixing base 200 may be clamped on the upper edge of the display.

The above descriptions are the preferred embodiments of the present disclosure and is not used to limit the present disclosure, and the person skilled in the art would have various changes and modifications on the present disclosure. The equivalent substitutions, modifications or changes according to the principle and the spirit of the present disclosure shall be included within the scope of protection of the present disclosure.

### LIST OF REFERENCE SIGNS

10: base
20: piezoelectric component
30: constraint part
40: flexible reflective sheet
401: reflective curved surface
41: first bent part
42: second bent part
S1: first surface
S2: second surface
50: support frame
501: bent surface
60: outer case
61: opening
611: attachment surface
D1: first distance
D2: second distance
M: preset surface
100: light emission device
200: fixing base

1. A light adjustment device comprising:
a base for disposing a light emission device thereon;
a piezoelectric component mounted on the base, wherein the piezoelectric component generates a deformation amount with a preset value toward a preset direction by changing a voltage inputted to the piezoelectric component; and
a flexible reflective sheet of which one side is fixed on the piezoelectric component;
wherein, the flexible reflective sheet generates a preset bend to form a reflective curved surface by a deformation of the piezoelectric component, and light emitted by the light emission device partially projects or entirely projects onto the reflective curved surface of the flexible reflective sheet and is reflected on a preset position.

2. The light adjustment device according to claim 1, wherein the piezoelectric component is a multilayer structure, and a surface on the one side of the flexible reflective sheet is attached to a surface of the piezoelectric component, and the flexible reflective sheet is connected and fixed to the piezoelectric component.

3. The light adjustment device according to claim 1, further comprising a constraint part, a preset distance between the constraint part and the piezoelectric component is constant, a relative position relationship between the constraint part and the piezoelectric component is invariable, and the flexible reflective sheet comprises a first side fixed on the piezoelectric component and a second side constrained by the constraint part.

4. The light adjustment device according to claim 3, further comprising a support frame which is fixed and connected to the base, and the support frame has a bent surface toward the flexible reflective sheet;
when the voltage inputted to the piezoelectric component is a first voltage, the flexible reflective sheet is bent to attach to the bent surface;
when the voltage inputted to the piezoelectric component is zero, the flexible reflective sheet is on a freely bent state;
when the voltage inputted to the piezoelectric component is a second voltage, at least one partial surface of the flexible reflective sheet is bent to detach from the bent surface.

5. The light adjustment device according to claim 4, wherein the constraint part is one part of the support frame, and the second side of the flexible reflective sheet is connected and fixed to the constraint part.

6. The light adjustment device according to claim 4, further comprising an opaque outer case with an opening, wherein the base, the support frame and the flexible reflective sheet are encased by the outer case, and the light reflected by the reflective surface of the flexible reflective sheet travels from the opening of the outer case.

7. The light adjustment device according to claim 6, wherein one end of the support frame far away from the piezoelectric component and the outer case forms the constraint part with a form of an included angle structure, and the second side of the flexible reflective sheet is inserted into the included angle structure.

8. The light adjustment device according to claim 7, wherein the opening of the outer case comprises a first side adjacent to the base and a second side adjacent to the flexible reflective sheet, and an attachment surface with a preset arc is disposed on the second side of the opening, and when the voltage inputted to the piezoelectric component is the second voltage, the surface of the second side of the flexible reflective sheet is attached to at least one partial surface of the attachment surface.

9. The light adjustment device according to claim 4, wherein when the flexible reflective sheet is bent to attach to the bent surface, the light emitted by the light emission device mounted on the base projects onto the reflective curved surface of the flexible reflective sheet and is reflected to form a first light beam;
when the at least one partial surface of the flexible reflective sheet is bent to detach from the bent surface, the light emitted by the light emission device mounted on the base projects onto the reflective curved surface of the flexible reflective sheet and is reflected to form a second light beam;
the first light beam projects onto a preset surface to form a first near illumination edge and a first far illumination edge, and a distance between the first near illumination edge and the first far illumination edge is denoted as a first distance;
the second light beam projects onto the preset surface to form a second near illumination edge and a second far illumination edge, and a distance between the second near illumination edge and the second far illumination edge is denoted as a second distance;
the first distance is greater than the second distance;
the first far illumination edge is farther from the light emission device than the second far illumination edge, and the first near illumination edge is farther from the light emission device than the second near illumination edge.

10. The light adjustment device according to claim 4, wherein the flexible reflective sheet comprises a first surface and a second surface which face away from each other, one side of the first surface on the first side of the flexible reflective sheet is attached and fixed to the piezoelectric component; at least one part of the second surface faces the light emission device and the second surface is configured to receive the light emitted by the light emission device;
when the voltage inputted to the piezoelectric component is the second voltage, at least one part of the first surface of the flexible reflective sheet withstands on the bent surface of the support frame.

11. The light adjustment device according to claim 3, wherein when the voltage inputted to the piezoelectric component is zero, the flexible reflective sheet is on the freely bent state and comprises a first bent part and a second bent part, and a bending direction of the first bent part is opposite to a bending direction of the second bent part;
when the voltage inputted to the piezoelectric component is greater than zero, a curvature of the first bent part and a curvature of the second bent part are changed by the deformation of the piezoelectric component.

12. An illumination device comprising:
a base for disposing a light emission device thereon;
a piezoelectric component mounted on the base, wherein the piezoelectric component generates a deformation amount with a preset value toward a preset direction by changing a voltage inputted to the piezoelectric component;
a flexible reflective sheet of which one side is fixed on the piezoelectric component; and
a fixing base, wherein a top of the fixing base is configured to mount the light adjustment device, and a bottom of the fixing base is configured to clamp on a preset object or is configured to be placed on a preset plane;
wherein, the flexible reflective sheet generates a preset bend to form a reflective curved surface by a deformation of the piezoelectric component, and light emitted by the light emission device partially projects or entirely projects onto the reflective curved surface of the flexible reflective sheet and is reflected on a preset position.

13. The illumination device according to claim 12, wherein the base is a circuit board which drives the piezoelectric component and the light emission device to operate.

14. The illumination device according to claim 12, further comprising a first circuit board and a second circuit board which are independent of each other and mounted on the base, and the piezoelectric component is mounted on the first circuit board, and the light emission device is mounted on the second circuit board.

15. The illumination device according to claim 12, wherein the flexible reflective sheet is an elastic metal sheet.
